(19) United States
(12) Patent Application Publication
(10) Pub. No.: US 2006/0019698 A1
(43) Pub. Date: Jan. 26, 2006

(54) Method and apparatus for radio system with multiple communication modes

(75) Inventors: Deepak Ahya, Plantation, FL (US); Daniel A. Baudino, Lake Worth, FL (US); Sanigepalli V. Praveenkumar, Sunrise, FL (US); Faisal Saeed, Sunrise, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/897,702

(22) Filed: Jul. 23, 2004

(51) Int. Cl. H04Q 7/20; H04B 1/38

(52) U.S. Cl. 455/552.1

(57) ABSTRACT

A radio communication system includes provider equipment and at least two subscriber radio units, each operable in a telephone communication mode and a dispatch communication mode. The provider equipment is operable to receive a communication request from a subscriber radio unit, the request including a requested communication mode and a mode-specific identifier identifying a target subscriber radio unit. The provider equipment compares the mode-specific identifier to the requested communication mode. If the mode-specific identifier does not match the requested communication mode, the provider equipment searches a provided database containing at least two mode-specific identifiers for each subscriber unit and, using the received mode-specific identifier, reads the mode-specific identifier matching the requested communication mode and, using the mode-specific identifier matching the requested communication mode, sets up communication between the originating subscriber radio unit and the target subscriber radio unit in the requested communication mode. As an alternative to the provider equipment cross-referencing a telephone number identifier from its database in response to a received private access identifier, a protocol to communicate data over voice channel can be used to query the phone number identifier directly from the target subscriber unit itself.

### BACKGROUND OF THE INVENTION

1. Field of the Invention

This invention relates in general to radio communication systems, and more particularly, to systems having subscriber units that support multiple communication modes.

2. Description of the Related Art

Wireless communication systems that utilize radio frequency carriers are well known in the art. Such systems offer services such as cellular telephone service, trunked dispatch services, paging services, and others. Recently, there has been a trend to offer multiple services on a single radio communication system. Some systems support subscriber units that offer both telephone interconnect and dispatch services, or telephone interconnect and paging services, among other combinations. The development of such systems has been evolutionary in nature. New services having differing characteristics are often grafted onto existing systems. Consequently, each service tends to have different access methodologies, including identifiers, initiation sequence, and the like.

Currently, a caller must know at least two numbers to utilize the telephone and dispatch functions of the subscriber unit: When a user attempts a telephone call, the user enters the telephone number of the target communicant and presses a “send” button to initiate the telephone call mode; when initiating a private call in dispatch mode, the user enters a subscriber unit's private dispatch identifier and a push-to-talk (“PTT”) button is pressed to initiate a call in dispatch mode.

In currently available systems, if a private dispatch identifier is entered as the phone number, the call will fail. Likewise, if a telephone number is entered as the private dispatch identifier, the call will also fail.

It is desirable to facilitate communications between subscriber units regardless of communication modes. Therefore, an improved call set up procedure is needed for multi-mode communication devices.

### SUMMARY OF THE INVENTION

The present invention provides for a simplified call procedure for communicating with subscriber units of a radio communication system having both a telephone communication mode and a dispatch communication mode. At a subscriber unit, a call request is initiated by providing either a telephone number identifier or a private dispatch identifier for a target subscriber unit and then selecting a particular two-way wireless communication mode. Each of the two-way wireless communication modes has a particular identifier format. The selected two-way wireless communication mode and provided identifier are communicated in a request for radio service to provider equipment that manages communication services within the radio communication system. At the provider equipment, the request for radio service to the target subscriber unit is received and the identifier is compared to the two-way wireless communication mode. If the identifier matches the two-way wireless communication mode, the desired two-way wireless communication mode is enabled at the target subscriber unit and communication between the originating subscriber unit and target subscriber is established.

If the identifier does not match the two-way wireless communication mode, the provider equipment searches its database using the mode-specific destination calling number to cross-reference the identifier assigned to the target subscriber for the two-way wireless communication mode requested, enables the desired two-way wireless communication mode to the target subscriber unit, and communication between the originating subscriber unit and target subscriber is established. As an additional feature, the provider equipment is able to transmit the identifier back to the originating subscriber unit for storage within a database on the originating subscriber unit for future use.

As an alternative to the provider equipment cross-referencing a telephone number identifier from its database in response to a received private access identifier, a protocol to communicate data over voice channel, such as iBroadcast, can be used to query the phone number identifier directly from the target subscriber unit itself.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a radio communication system, in accordance with the present invention;

FIG. 2 is a block diagram of a radio communication device operating within the system of FIG. 1, in accordance with the present invention;

FIG. 3 is a diagram of a call setup message structure, in accordance with the present invention;

FIG. 4 is a block diagram of provider equipment within the radio communication system of FIG. 1, highlighting important functional blocks, in accordance with the present invention;

FIG. 5 is a flowchart of procedures for the radio communication device of FIG. 2, in accordance with the present invention;

FIG. 6 is a flowchart of procedures for operating the provider equipment of FIG. 1, in accordance with the present invention;

FIG. 7 is a flowchart of procedures for operating the provider equipment of FIG. 1, in accordance with one embodiment of the present invention;

FIG. 8 is a flowchart of procedures for operating the provider equipment of FIG. 1, in accordance with one embodiment of the present invention;

FIG. 9 is a block diagram of the call setup procedure, in accordance with one embodiment of the present invention; and

FIG. 10 is a block diagram of the call setup procedure, in accordance with one embodiment of the present invention.

### DETAILED DESCRIPTION OF THE PREFERRED EMBODIMENTS

While the specification concludes with claims defining the features of the invention that are regarded as novel, it is believed that the invention will be better understood from a consideration of the following description in conjunction with the drawing figures, in which like reference numerals are carried forward.

System and Network Overview

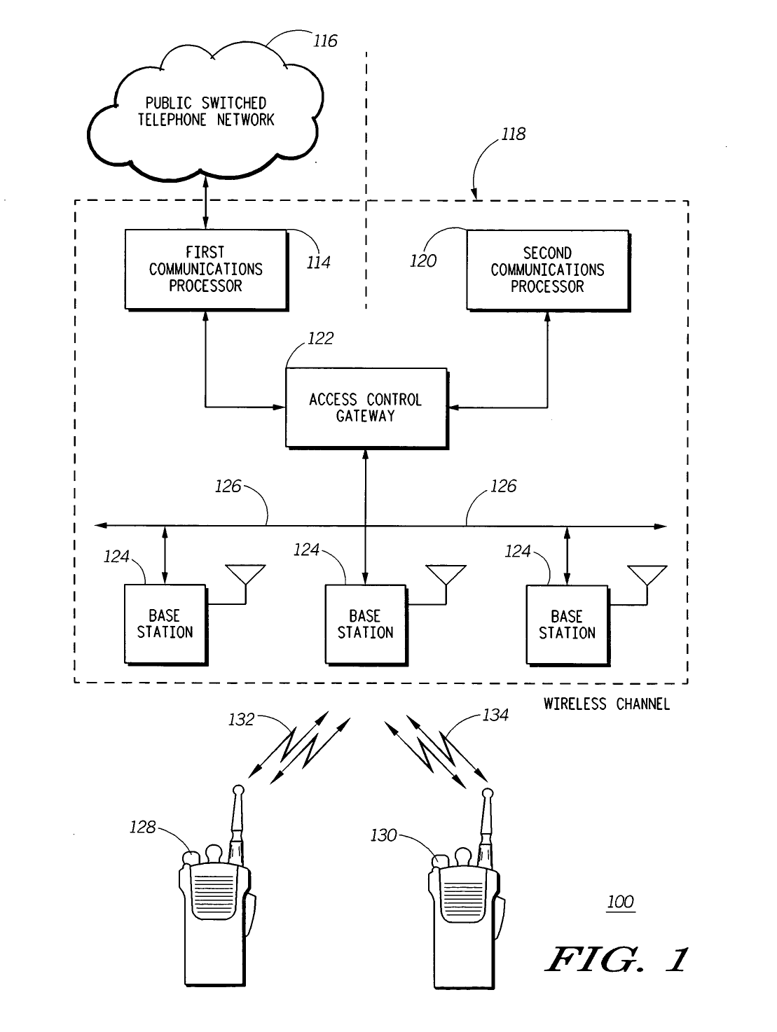

FIG. 1 shows a block diagram of a radio communication system 100, in accordance with the present invention. The radio communication system 100 includes provider equipment 118, which is coupled to a public switched telephone network 116 and subscriber units 128, 130. The provider equipment 118 includes an access control gateway 122, a first and a second communications processor 114 and 120, a communication channel 126, and base stations 124. In a preferred embodiment, the access control gateway 122 performs communication management and access control for the subscriber units 128, 130, in a manner well known in the art. The first communications processor 114 interfaces with the public switched telephone network 116 and the access control gateway 122 to provide a gateway for managing and routing messages to and from particular subscriber units 128, 130 requesting a telephone two-way wireless communication mode or receiving communications in a telephone two-way wireless communication mode. These messages may be obtained from a source outside the radio communication system via the public switched telephone network 116, or may be sourced from an internally serviced subscriber unit 128, 130 or other equipment. The second communications processor 120 is used to provide direct communication between the originating subscriber and the target subscriber without accessing the public switched telephone network 116. The base stations 124 are coupled to the access control gateway 122 and are ordinarily geographically dispersed to service subscriber units in specific geographic regions. The subscriber units 128, 130 are radio communication devices that interface with the access control gateway 122 via wireless communication links 132, 134 established with the base stations 124. The subscriber units 128, 130 may be portable or mobile radio telephones that work in conjunction with the provider equipment 118 to provide a user with services such as telephone interconnect, short message service, dispatch or instant conferencing, circuit data, packet data, and combinations thereof, as well as other data services.

Subscriber Units

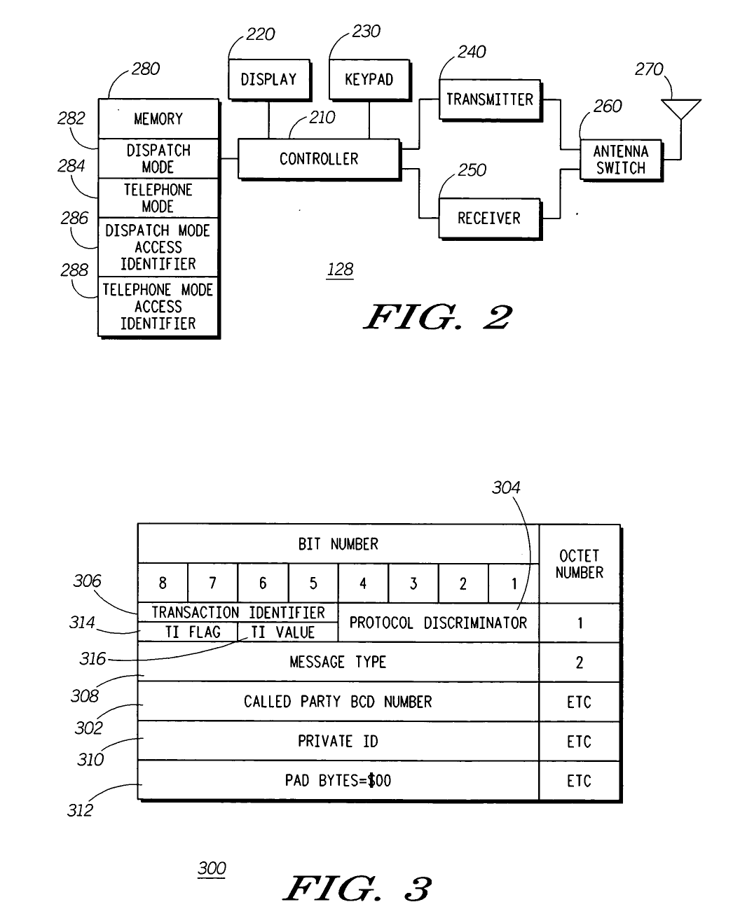

FIG. 2 shows a block diagram of a radio communication device, such as wireless subscriber unit 128, in accordance with the present invention. Other subscriber units 130 are similarly constructed. The communication device 128 is preferably a two-way radio or radio telephone that is operable to provide at least telephone interconnect and dispatch services. In the radio 128, a controller 210 is coupled to a memory device 280, to a transmitter 240, and to a receiver 250. The transmitter 240 and receiver 250 are coupled via an antenna switch 260 to an antenna 270. For transmit operations, the controller 210 configures the antenna switch 260 to couple the transmitter 240 to the antenna 270. Similarly, for receive operations, the controller 210 couples the antenna 270 via the antenna switch 260 to the receiver 250. The receive and transmit operations are conducted under instructions stored in the memory 280. The radio 128 also includes a display 220 and keypad 230 that together provide a user interface for accessing radio functions. The memory 280 further includes information on dispatch mode private access identifiers 286 and telephone mode access identifiers 288 and two-way wireless communication modes, such as dispatch 282 and telephone interconnect 284. The radio 128 is operable to select a particular two-way wireless communication mode from among dispatch mode and telephone interconnect mode for communication with another subscriber unit. The radio 128 is also operable to transmit a selected two-way wireless communication mode together with a particular access identifier to provider equipment when requesting a call setup.

Call Setup Message

FIG. 3 shows the structure of a call request with a setup message 300 containing an identifier. When a user enters an identifier, followed by selection of a two-way wireless communication mode and request for service, the subscriber unit fills in all the appropriate fields shown in the message format of FIG. 3. Each message consists of a Protocol Discriminator 304, a Transaction Identifier 306, a Message Type 308, and a Called Party BCD Number (telephone access identifier) 302, or an Private ID (private access identifier) 310. In addition, there may also be Optional Information Elements (not shown) and Pad bytes 312, equal to $00 (binary numbers are indicated by the prefix “%” and hexadecimal numbers are indicated by the prefix “$”), as required to pad the message out to a particular length.

Bit Ordering and Numbering

Bits within each octet are numbered 1 through 8. The right-most column in FIG. 3 indicates the octet number. The higher-numbered bits are more significant. If a field spans more than one octet, then the most significant bit of the field is the highest-numbered bit of the lowest-numbered octet, and the least significant bit is the lowest-numbered bit of the highest numbered octet.

Protocol Discriminator

The protocol discriminator 304 is used to distinguish between the message sets used by the various message protocol entities. Table 1 shows a list of the various entities corresponding to protocol discriminator values.

TABLE 1

| PD | Message Entity |
|---|---|
| $3 | Call Control |
| $5 | Mobility Management |
| $6 | Resource Management |
| $7 | Resource Management |
| $9 | SMS Support |
| $B | Supplementary Services |

Transaction Identifier

The transaction identifier 306 is used by some protocol entities to distinguish between simultaneous activities within a single Message Service. As shown in FIG. 3, the transaction identifier 306 is made of the transaction identifier flag 314 and the transaction identifier value 316. Transaction identifier values are chosen and assigned by the side of the interface initiating a transaction. At the beginning of a transaction a free transaction identifier value is chosen and assigned to the transaction; it then remains fixed for the lifetime of the transaction. When the transaction ends, the associated transaction identifier value is freed and may be re-assigned to another transaction.

The transaction identifier flag 314 is used to prevent ambiguities that would result if both sides of the interface should happen to choose the same transaction identifier value 316 for different transactions. The transaction identifier flag 314 identifies which side of the interface chose the transaction identifier value 316.

Message Type

The Message Type 308, together with the Protocol Discriminator 304, identifies the function of a particular message. The message type 308 is used to indicate to the provider equipment whether the two-way wireless communication mode being requested by the originating subscriber unit is telephone or dispatch.

Provider Equipment

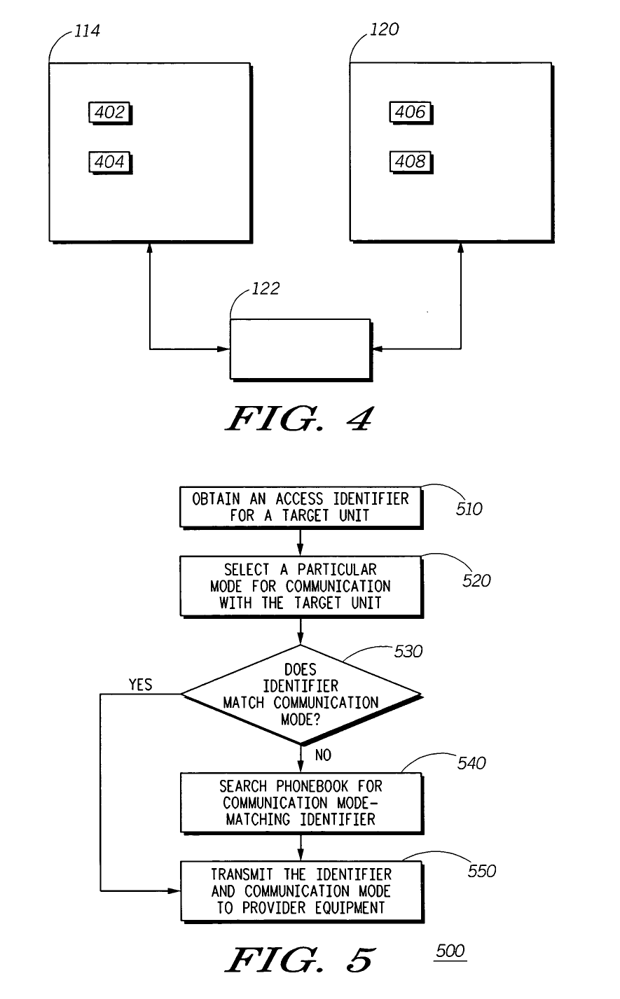

FIG. 4 is a block diagram highlighting significant aspects of the provider equipment 118 and includes the first communications processor 114 and the second communications processor 120. The first communications processor 114 is provided with a dispatch database 402 and telephone database 404. Similarly, the second communications processor 120 is provided with a dispatch database 406 and telephone database 408. Each processor 114 and 120 also includes hardware and software that implement management and control functions for the provider equipment 118. Once the base station 124 receives a request for service from a subscriber unit, the request is sent to the access control gateway 122, which routes the request to either the first communications processor 114 or the second communications processor 120 dependent on the two-way wireless communication mode requested by the user. If the two-way wireless mode requested is telephone mode, the call is routed to the first communications processor 114. If the two-way wireless mode requested is a dispatch mode, the call is routed to the second communications processor 120. Each of the processors 114, 120 is provided with a dispatch database 402, which contains dispatch operability information for a set of subscriber units 128, 130. This information includes a record for each subscriber unit that contains a private access identifier. Each processor 114, 120 is also provided with a telephone database 404, which contains telephone operability information for a set of subscriber units that have telephone service capability. The telephone database 404 contains telephone access identifiers. In the preferred embodiment, the telephone access identifier 288 has the format of a telephone number, including any necessary geographically based codes, such as area codes, that are required to maintain a unique number for that subscriber unit.

Procedures at Subscriber Unit

FIG. 5 shows a flowchart of procedures 500 used at the communication device 128, 130 when initiating a request for radio service or communication with another subscriber unit. The communication device obtains a mode-specific access identifier for the target subscriber unit, step 510. The access identifier is termed mode-specific as this identifier identifies the target subscriber unit in a format consistent with an available two-way wireless communication mode. For the telephone mode, the access identifier is preferably a telephone number with any necessary geographic designators, such as area codes, country codes, and the like. For the dispatch mode, the access identifier can be any format interpretable by the system to route the request for service to the target subscriber. A user operates the communication device 128, 130 to select a particular two-way wireless communication mode from among the supported two-way wireless communication modes for communication with another subscriber unit, step 520. The communication device then compares the two-way wireless communication mode and the access identifier, step 530. If the access identifier is for a two-way wireless communication mode other than the mode requested, the device searches an internal database (“phonebook”) for a mode-matching identifier, step 540. If a mode-matching identifier is located, such as by use of a comparator, the entered identifier is replaced with the matching identifier and transmitted along with the selected two-way wireless communication mode on a wireless communication channel to the provider equipment, step 550. If the matching identifier is not located, the non-matching identifier is transmitted along with the selected two-way wireless communication mode on a wireless communication channel to the provider equipment, step 550.

### Procedures for Non Peer-to Peer Embodiment

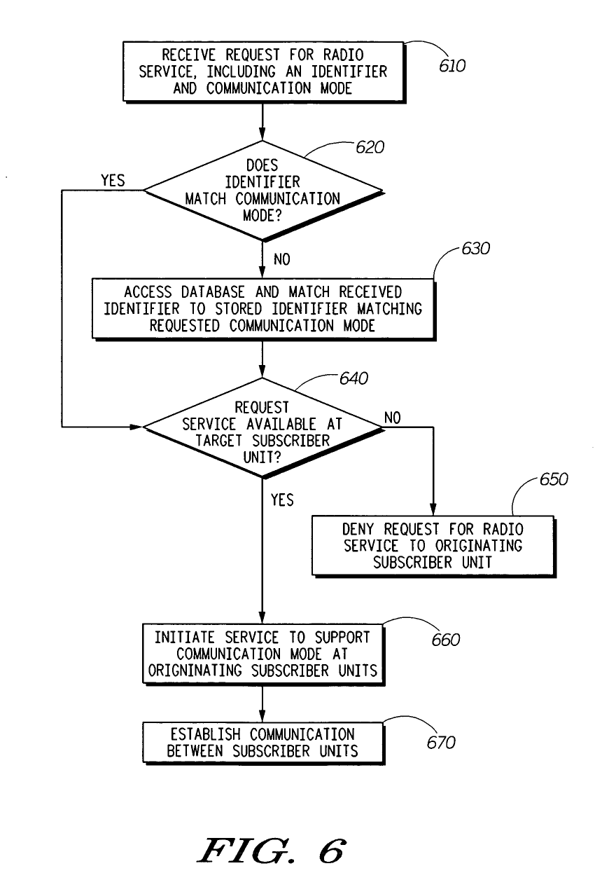

FIG. 6 shows a flowchart of procedures 600 used at the provider equipment to process requests for communications with a particular subscriber unit, in accordance with the present invention. The provider equipment receives a request for radio service, which request includes an access identifier and a preferred two-way wireless communication mode for a target subscriber unit, step 610. In one embodiment, the request is received via a wireless communication channel when sourced at a subscriber unit. However, the request may be sent via a wired communication link, particularly when the request originates outside the radio communication system. The provider equipment compares the access identifier to the two-way wireless communication mode requested, step 620. If the identifier does not match the mode, the provider equipment accesses its databases for subscriber unit information using the mode-specific destination calling number as a key, step 630. Once the identifier is found that matches the requested mode, such as by way of a comparator, step 630, or if the mode-specific destination calling number received matches the requested mode without the necessity of a database search, the provider equipment determines whether the preferred two-way wireless communication mode is available at the target subscriber unit, and denies the request for radio service when the particular two-way wireless communication mode is not available at the targeted subscriber unit, steps 640, 650. When the particular two-way wireless communication mode is available at the target subscriber unit step 640, the provider equipment accesses the target subscriber unit and initiates service to support the two-way wireless communication mode at the subscriber unit, step 660. Ordinarily, the provider equipment enables the two-way wireless communication mode at the target subscriber unit, and establishes communication with that subscriber unit, step 670.

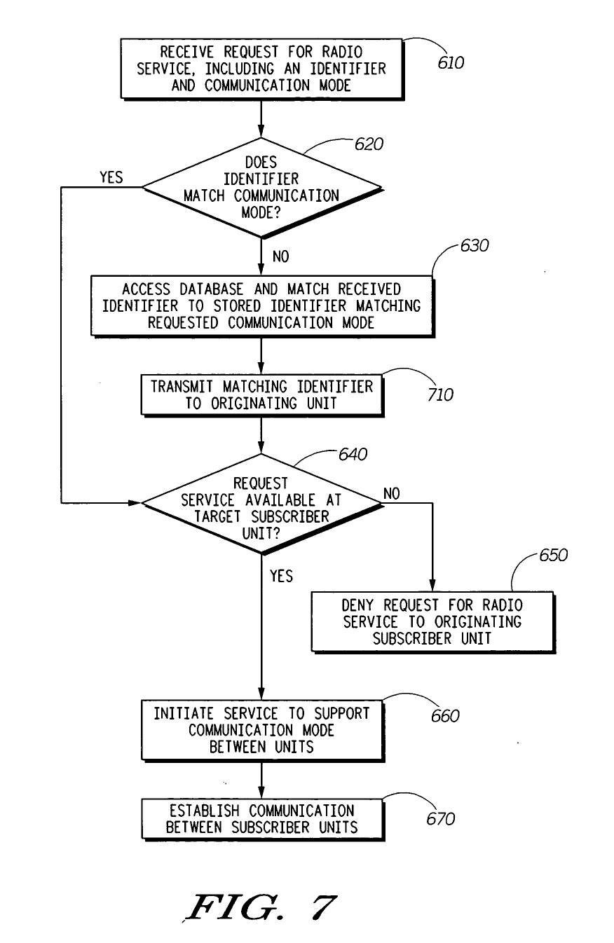

FIG. 7 shows a flowchart of procedures 700 similar to those shown in FIG. 6, with an optional step in accordance with the present invention. After the provider equipment determines that the identifier matches the requested two-way wireless communication mode, step 620, or the provider equipment accesses a stored identifier matching the requested two-way wireless communication mode, step 630, the identifier matching the requested two-way wireless communication mode is transmitted back to the requesting subscriber unit for storage and later usage by the requesting subscriber unit, step 710. As an additional feature, when the provider equipment requests service at the target subscriber unit, step 640, an identifier identifying the originating unit can be transmitted to the target subscriber.

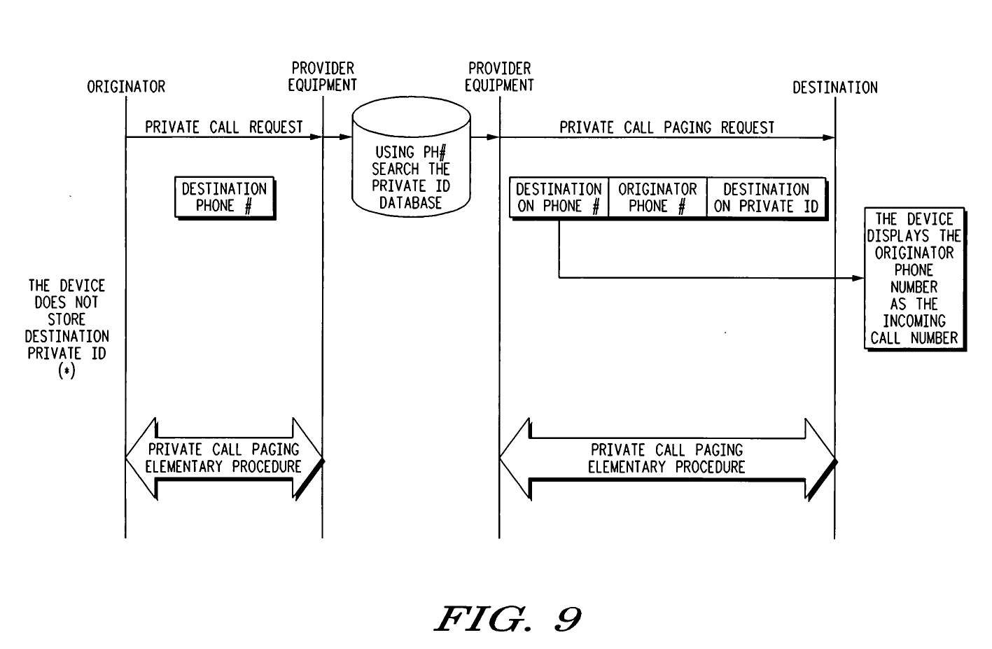

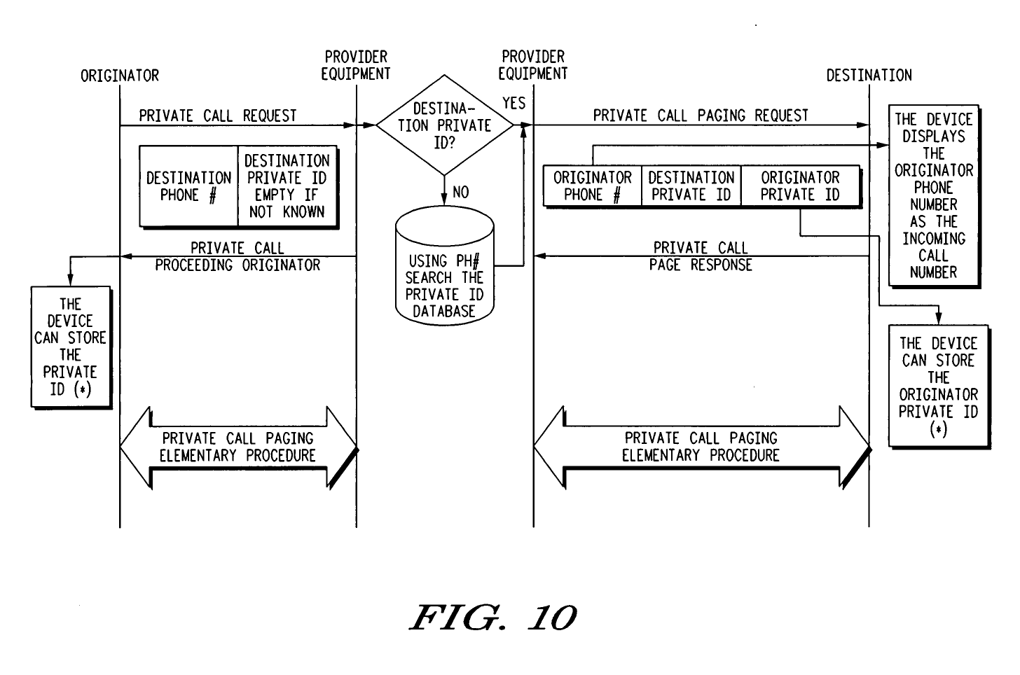

Referring now to FIGS. 9 and 10, the above-described call procedures are shown diagrammatically. In both figs, a telephone mode access identifier is entered into the originating subscriber unit and a push-to-talk button is pushed to transmit the communication request to the provider equipment in dispatch two-way wireless communication mode. FIG. 9 corresponds to the flow chart of FIG. 7, where no destination subscriber unit private communication identifier is sent to, and stored on, the originating subscriber unit.

### Procedures for Peer-to Peer Embodiment

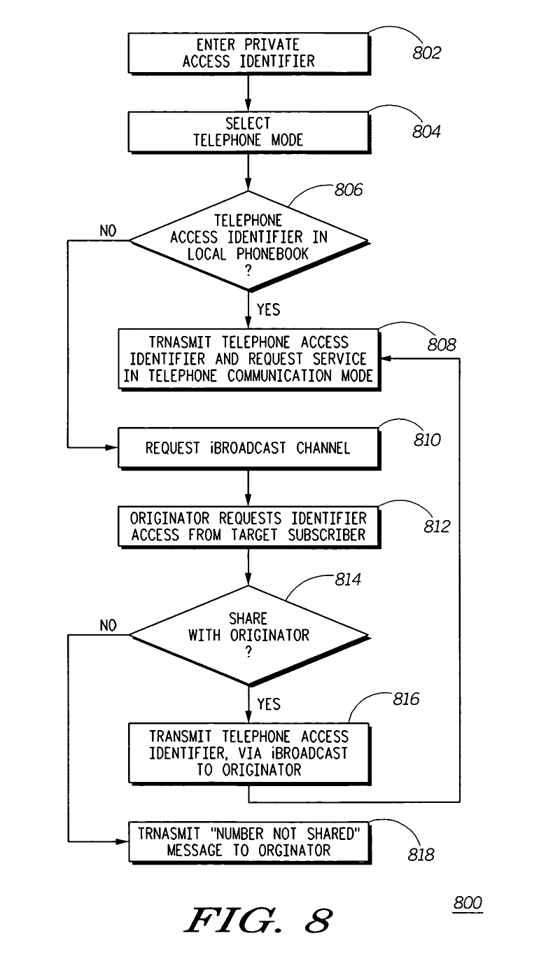

A protocol to communicate data over a voice channel, such as iBroadcast, is a web-based service that allows users to communicate with one another via the internet. Mobil users can access the internet via public switched telephone network 116 and communicate through a protocol to communicate data over voice channel. FIG. 8 shows a flowchart of procedures 800 for peer-to-peer communication between an originating unit and a target unit using a protocol to communicate data over voice channel, in accordance with the present invention. A user enters a private access identifier for the target subscriber, step 802. Alternatively, the phone can be provided with a database (“phonebook”) containing access identifiers for a group of subscribers and a user can enter the target subscriber's access identifier by simply selecting the subscriber's name from a list. The user then places the phone into telephone two-way wireless communication mode, step 804. The phone queries its local phonebook for a telephone access identifier, step 806. If the telephone access identifier is found, the unit transmits the telephone access identifier and requests service in telephone two-way wireless communication mode from the provider equipment, step 808. If the telephone access identifier is not found in the local phonebook, the unit requests a protocol to communicate over voice channel, step 810. Once communication of data over voice channel has been established, the originator performs a query on the target subscriber, soliciting its network identifier, i.e., sends a request to the target subscriber unit for access to its assigned telephone access identifier, step 812. The subscriber units can be provided with settings for shared access permission levels, allowing a unit to share information with all requesters, no requesters, or requesters belonging to a specific predefined group. The target subscriber unit verifies that its telephone access identifier can be shared with the originating subscriber unit, step 814. If the information can be shared, the telephone access identifier is transmitted via the protocol to communicate data over voice channel back to the originating subscriber unit, step 816. Additional information can be transmitted along with the telephone access identifier sent in step 816. For instance, a VCard can be sent, which is a grouping of data, containing a user's information, similar to that found on a business card. Examples of such information includes name, address, telephone number, email address, place of employment, title, and more.

If the telephone access identifier cannot be shared with the originating subscriber unit, a message communicating such, for example, “number not shared”, is sent via the protocol to communicate data over voice channel to the originating subscriber unit, step 818. If the telephone access identifier is shared, the originating unit requests a connection with the target subscriber unit via telephone two-way wireless communication mode, from the provider equipment, step 808.

FIG. 10 corresponds to the procedure shown in the flow chart of FIG. 8, where the private ID is transmitted to, and stored on, the originating subscriber unit. FIG. 10 also shows an additional optional feature of the present invention. When the provider equipment 118 initiates the service to support the requested two-way wireless communication mode with the destination subscriber unit, the originating subscriber unit's private access identifier and telephone access identifier are transmitted to the destination subscriber unit and the destination subscriber unit can display either number as the incoming number.

Communication Modes

Several two-way wireless communication modes have been referenced above. A brief description of the modes previously referenced, as well as several other modes available for communications as described above, follow:

GSM—Global System for Mobile Communications uses narrowband TDMA (explained below), which allows eight simultaneous calls on the same radio frequency. GSM is one of the leading digital cellular systems.

TDMA—Time Division Multiple Access is a technology for delivering digital wireless service using time-division multiplexing (TDM). TDMA works by dividing a radio frequency into time slots and then allocating the slots to multiple calls. This system gives a single frequency the ability to support multiple, simultaneous data channels.

CDMA—Code-Division Multiple Access is a digital cellular technology that uses spread-spectrum techniques. Unlike the GSM system, that uses TDMA, CDMA does not assign a specific frequency to each user. Instead, every channel uses the full available spectrum. Individual conversations are encoded with a pseudo-random digital sequence.

WCDMA—Wideband CDMA is a high-speed 3G mobile wireless technology with the capacity to offer higher data speeds than CDMA. WCDMA can reach speeds of up to 2 Mbps for voice, video, data and image transmission.

TDM—Time Division Multiplexing is a type of multiplexing that combines data streams by assigning each stream a different time slot in a set. TDM repeatedly transmits a fixed sequence of time slots over a single transmission channel.

IPng—Internet Protocol next generation is a version of the Internet Protocol (IP) reviewed in IETF standards committees to replace IP version 4. The protocol is officially referred to as IPv6, where the v6 stands for version 6.

IP—Internet Protocol specifies the format of packets, also called datagrams, and the addressing scheme. Most networks combine IP with a higher-level protocol called Transmission Control Protocol (TCP), which establishes a virtual connection between a destination and a source.

WLAN—Wireless Local-Area Network is a type of network that uses radio waves rather than wires to communicate between network nodes.

SMS—Short Message Service is the transmission of short text messages to and from a mobile phone, fax machine and/or IP address. Messages must be no longer than 160 alpha-numeric characters and contain no images or graphics. Once a message is sent, it is received by a Short Message Service Center (SMSC), which must then get it to the appropriate mobile device. To do this, the SMSC sends a SMS Request to the home location register (HLR) to find the roaming customer. Once the HLR receives the request, it will respond to the SMSC with the subscriber's status: 1) inactive or active, and 2) where the subscriber is roaming.

MMS—Multimedia Message Service is a store-and-forward method of transmitting graphics, video clips, sound files and short text messages over wireless networks using the WAP protocol. MMS also supports e-mail addressing, so the device can send e-mails directly to an e-mail address. The most common use of MMS is for communication between mobile phones.

MMS, however, differs from email. MMS is based on the idea of multimedia messaging. The presentation of the message is coded into the presentation file so that the images, sounds and text are displayed in a predetermined order as one singular message. MMS does not support attachments as e-mail does. MMS appears is similar to SMS to an end user.

VoIP—Voice over Internet Protocol is a category of hardware and software that enables people to use the Internet as the transmission medium for telephone calls by sending voice data in packets using IP rather than by traditional circuit transmissions of the PSTN. This method of transmitting telephone calls has the advantage of avoiding surcharges beyond what the user is paying for Internet access.

### CONCLUSION

The present invention offers significant advantages over the prior art of record. Communication to a particular subscriber unit is enabled using a mode-specific access identifier which uniquely identifies the subscriber unit within the radio communication system, regardless of actual two-way wireless communication mode chosen by the user. Thus, a single access identifier may be used, regardless of two-way wireless communication mode, when communication is desired with a particular subscriber unit. As a result, communication services can be provided in an efficient and less restrictive manner.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the appended claims.

What is claimed is:

1. A two-way wireless communication system for establishing wireless connections between a plurality of subscriber units over a plurality of available wireless communications modes, the wireless communication system comprising:
a transceiver that receives from at least a first wireless subscriber unit a call request with a first two-way wireless communication mode and a mode-specific destination calling number of at least a second wireless subscriber unit;
a database searchable by the mode-specific destination calling number to find at least an additional mode-specific destination calling number; and
a comparator operable to compare the received mode-specific destination calling number with the first two-way wireless communication mode;
wherein, the system transmits the call request over the first two-way communication mode to the second wireless subscriber unit using the additional mode-specific destination calling number.

2. The two-way communication system according to claim 1, wherein the first two-way wireless communication mode comprises:
a telephone mode.

3. The two-way communication system according to claim 1, wherein the second two-way wireless communication mode comprises:
a dispatch mode.

4. The two-way communication system according to claim 1, wherein each of the mode-specific destination calling numbers is one of a telephone number and a private dispatch identifier.

5. The two-way communication system according to claim 1, wherein the first two-way wireless communication mode is dispatch mode and the mode-specific destination calling number is a telephone number of the second wireless subscriber unit.

6. The two-way communication system according to claim 1, wherein the first two-way wireless communication mode is telephone mode and the mode-specific destination calling number is a private dispatch identifier of the second wireless subscriber unit.

7. The two-way communication system according to claim 1, further comprising:
including in the call request transmitted by the system, an identifier identifying the first wireless subscriber unit.

8. The two-way communication system according to claim 1, further comprising:
transmitting the additional mode-specific destination calling number to the first wireless subscriber unit.

9. The two-way communication system according to claim 1, wherein the first two-way communications mode is selected from a group of communication modes consisting of Code-Division Multiple Access (CDMA), Time-Division Multiple Access (TDMA), Wideband CDMA (WCDMA), Global System for Mobil Communication (GSM), Time Division Multiplexing (TDM), Voice Over IP (VoIP), iBroadcast, CDMA Push To Talk (PTT), Internet Protocol (IP), Internet Protocol Next Generation (IPng), Wireless Local-Area Network (WLAN), MotoTalk, interconnect, Short Message Service (SMS), Instant Messaging, Video conferencing, e-mail, and Multimedia Messaging Service (MMS)

10. The two-way communication system according to claim 1, wherein the system initiates service to support the first communication mode at the second wireless subscriber unit and enables communication between the first and second wireless subscriber units.

11. A two-way wireless device in a peer-to-peer network comprising:
a transceiver for sending over a first communications mode a query for a network identifier to at least a second two-way wireless device, wherein the network identifier is associated with a second communications mode and the first communications mode is a peer-to-peer communications mode;
a comparator to determine if a connection has been established with the second two-way wireless device, and in response to a connection being made, receiving from the second two-way wireless device the network identifier associated with the second communications mode; and
a memory device for storing the network identifier received from the second two-way wireless device for use over a second communications mode.

12. The two-way wireless device according to claim 11, wherein the query for a network identifier includes at least one of a name, address, and company, and the memory device stores at least some of this information received along with the network identifier.

13. The two-way wireless device according to claim 11, wherein the query for a network identifier includes a query for a VCard.

14. A two-way wireless device in a peer-to-peer network comprising:
a transceiver for receiving over a first communications mode a query for a network identifier from at least a second two-way wireless device, wherein the network identifier is associated with a second communications mode and the first communications mode is a peer-to-peer communications mode; and
a comparator to determine if permission to share the network identifier is granted;
wherein, if permission to share is granted, the device transmits the network identifier associated with the second communications mode to the second two-way wireless device.

15. The two-way wireless device according to claim 14, wherein the transmitted network identifier includes at least one of a name, address, and company.

16. The two-way wireless device according to claim 14, wherein the network identifier is transmitted in the form of a VCard.
